(19) United States
(12) Patent Application Publication
(10) Pub. No.: US 2023/0011194 A1
(43) Pub. Date: Jan. 12, 2023

(54) SUPPORT POLE ASSEMBLY FOR CONSTRUCTION BARRICADES

(71) Applicant: Israel E Arredondo, Pleasonton, TX (US)

(72) Inventor: Israel E Arredondo, Pleasonton, TX (US)

(21) Appl. No.: 17/373,211

(22) Filed: Jul. 12, 2021

(51) Int. Cl. E04H 17/08; F16M 13/02

(52) U.S. Cl. CPC E04H 17/08; F16M 13/022; F16M 2200/08

(57) ABSTRACT

A construction barricade support assembly includes a pole section having a tip configured with a loop to hold a barricade tape material. A base component is configured to support the pole section, the base component including at least one magnet to magnetically attach the construction barricade support assembly to a ferromagnetic material used as a support for the construction barricade support assembly.

### CROSS-REFERENCE TO RELATED APPLICATIONS

None.

### BACKGROUND

### Field of the Art

This disclosure relates to construction site equipment and, specifically, to a support pole assembly with a base incorporating magnets that permits safety barricades to be quickly set up, moved, adjusted, and taken down, while still providing firm support for the safety barricade that is resistant to being inadvertently moved or knocked over.

### Discussion of the State of the Art

Construction sites have rigid safety standards imposed by the Occupational Safety and Health Administration (OSHA) for providing barricades for the safety of construction workers and passersby.

The conventional construction barricade consists of barricade cones, sometimes referred to as “candlesticks”, that are lined up to form a construction site barricade, as often seen on highway construction sites having many candlestick cones lined up to demarcate one or more lanes of traffic intended as being blocked off from traffic. Each of these conventional candlestick cones are constructed of a rubber material having typical heights of 36″ to 42″, with a support base to maintain the cone in an upright position, thereby allowing the cones to be easily placed and moved as the construction site evolves.

OSHA also requires barricades be used on construction sites such as building projects. For example, forming barricaded zones around certain construction machines such as one-man lifts, scissor lifts, etc., may be required. Further, it may be desirable to form barricades indicating dangerous areas such as construction areas that are potentially dangerous to construction workers or passersby because of possible falling objects or areas such as walkways or edges of buildings that may present a hazard of someone falling. Typically, this type of barricade cones is configured with a loop permitting brightly-colored barricade tape to be used to provide a clear indication of the area intended as being barricaded off for safety. Alternative to tape, it is common to also use other materials, such as a rope, cable, or wire to form the barricade. Accordingly, in this disclosure, the term “barricade tape” is intended as having a generic meaning that includes materials other than tape.

The present inventor has recognized that such barricade cones used on construction sites can be inconvenient to set up and, if needed, to move as the construction site barricaded area evolves over time. Further, these barricade cones are subject to being inadvertently dislocated or knocked over. The present invention provides an alternative to the conventional candlestick cones for construction sites requiring barricade tape around construction equipment and around construction areas intended as being barricaded for safety.

### SUMMARY

The present invention provides a support pole configured to be magnetically attached to construction equipment and to steel construction members, for purpose of setting up construction site barricades using barricade tape.

The invention thereby permits quick and easy installations of construction site barricades that are also easy to move and remove as desired as hazardous areas evolve during the construction project.

Because the barricaded areas using the support poles of the present invention can be magnetically attached to ferromagnetic metal surfaces that are relatively stationary, the barricaded areas using such support poles are more stable than barricades formed using rubber candlestick cones that are subject to unintentional movement by such forces as wind or unintentional bumps by workers or equipment.

Additionally, because the support poles of the invention are firmly attached at their base, these support poles can securely define a construction barricaded area by using a single support pole at each corner of the area intended to be barricaded, rather than having to use multiple candlestick cones to define the same area.

The invention can also be used in combination with conventional candlestick cones having loops on their tops for holding barricade tape, should a barricade have to be made over areas in which magnetic attachment points are not available throughout the length of the barricade.

The barricade support assemblies of the present invention provide barricade supports that are lighter and easier to handle than conventional candlestick cones, take up less storage space, and provide a stronger attachment mechanism that resists inadvertent movement or being pushed over as commonly occurs with candlestick cone barricades.

### BRIEF DESCRIPTION OF THE DRAWING FIGURES

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates a prototype embodiment of the present invention, as attached to a metal construction site component.

FIG. 2 illustrates an exemplary embodiment of the invention in isolation.

FIG. 3 illustrates an exploded view of the assembly of the exemplary embodiment shown in FIG. 2.

FIG. 4 illustrates views of the outer pole of an exemplary embodiment of the invention.

FIG. 5 illustrates views of the inner pole of an exemplary embodiment of the invention.

FIG. 6 illustrates views of a spring-loaded base of an exemplary embodiment and that permits the angle of the support poles to be set at any one of possible preset angles.

FIG. 7 illustrates a view of a bushing that provides capability to easily change the angle of the support poles.

FIG. 8 illustrates a view of a shaft in an exemplary embodiment.

FIG. 9 illustrates how the support pole assembly of the invention could be used at a corner of a metal support component in a manner that demonstrates how one support pole could be extended and angled in a manner to provide a barricade tape attachment for two edges of a barricaded area.

FIG. 10 illustrates an alternative method of permitting the angle of the support poles to be selectively set at different angle, as using a plurality of holes in the base and a pin inserted at the selected angle setting.

### DETAILED DESCRIPTION

The present invention provides a barricade support pole that can simplify the setting up of construction barricades using barricade tape as required under current OSHA requirements and that will provide a barricaded area that is more firmly established and less prone to inadvertent movement or dislodging than conventional cones used to form construction barricades.

It is noted that in the following description, the terms “pole” and “rod” can be used interchangeably in the following description. The term “barricade tape” is intended as a generic term that includes not only colored plastic tape often used to form the barricade lines but also wire, cable, rope, or other materials that can also be used for forming such barricade lines.

The invention is described by reference to various elements herein. It should be noted, however, that although the various elements of the inventive apparatus are described separately below, the elements need not necessarily be separate. The various embodiment may be interconnected and may be cut out of a singular block or mold. The variety of different ways of forming an inventive apparatus, in accordance with the disclosure herein, may be varied without departing from the scope of the invention.

Generally, one or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices and parts that are connected to each other need not be in continuous connection with each other, unless expressly specified otherwise. In addition, devices and parts that are connected with each other may be connected directly or indirectly through one or more connection means or intermediaries.

A description of an aspect with several components in connection with each other does not imply that all such components are required. To the contrary, a variety of optional components may be described to illustrate a wide variety of possible embodiments and in order to more fully illustrate one or more embodiments. Similarly, although process steps, method steps, or the like may be described in a sequential order, such processes and methods may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, or method is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Alternate implementations are included within the scope of various embodiments in which, for example, functions may be executed out of order from that shown or discussed, including substantially concurrently or in reverse order, depending on the functionality involved, as would be understood by those having ordinary skill in the art.

### Overview

The apparatus of the present invention is an alternative to conventional candlestick cones used to construct temporary barricades on construction sites. The apparatus of the present invention is a barricade support pole assembly that will provide a more firmly-established barricaded area that is resistant to inadvertent movement and dislodging and is easy to set up, relocate, and take down.

### Apparatus

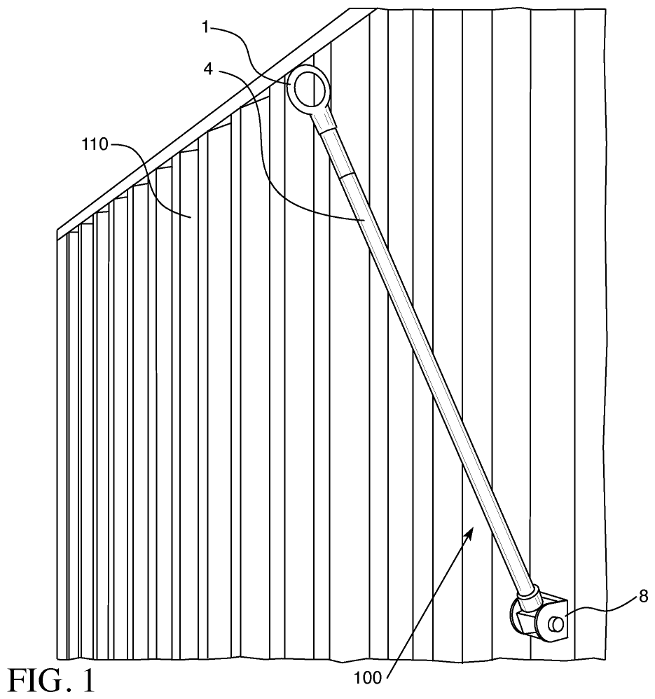

FIG. 1 illustrates the inventive apparatus in accordance with an embodiment of the invention. In particular, FIG. 1 shows a prototype barricade support pole assembly 100 as firmly attached magnetically at its base 8 to a steel structure 110 at a construction site, for example, a sidewall of a metal storage container. Although steel is commonly present on a construction site, any material having magnetic properties (for example, ferromagnetic) could be used as an attachment for the support pole assembly 100. Pole 4 is configured with a loop 1 at its distal tip through which barricade tape (not shown in FIG. 1) can be threaded to thereby form a construction site tape barricade.

By using a magnetic attachment to a ferromagnetic metal component 110, the barricade tape support pole 4 is much more rigidly supported than would be barricades formed using conventional rubber candlestick cones and therefore more secure against being inadvertently moved or knocked over. In an exemplary prototype, the base 8 is designed with, for example, three magnet elements that together provide an attachment strength of 300 pounds magnetic holding power.

It should also be clear that such magnetic attachment mechanism allows the barricade support pole assembly 100 to be easily applied to many construction components often made of iron or steel, including, for example, steel components such as temporary or permanent beams or columns that are components of a project under construction, sides of a metal storage or refuse container, the top of a metal plate used as a ground cover or a temporary cover over an opening, or even to support structure components of a piece of construction equipment such as a scissor lift, forklift, crane, truck, dozer, etc. Additionally, because of the strength of the attachment magnets used in the base of the present invention, it would be quite possible to attach the support pole assembly to a surface that is non-ferromagnetic if, for example, a steel rebar is embedded in concrete or covered by sheetrock and the steel rebar is close enough to the surface of the non-ferromagnetic material to permit a sufficiently strong magnetic attraction to the base magnets of the support pole assembly.

Additionally, should a barricade have to be made over a long stretch of length in which magnetic attachment points are not available throughout the length of the barricade, the support pole of the invention can also be used in combination with conventional candlestick cones having loops on their tops for holding barricade tape.

Thereby, the support pole assembly 100 of the present invention provides a very simple and quick way to construct construction site barricades that are resistant to being inadvertently dislocated or knocked over. Moreover, the magnetic attachment to an underlying magnetic material can also easily broken by rocking the tip 1 to intentionally and easily crack open the magnetic attachment, using an edge of the assembly 100 as a fulcrum and the pole 4 as a lever, thereby permitting the barricade to be moved or removed as desired in spite of its 300 pound magnetic attachment force.

Although FIG. 1 exemplarily shows the support pole assembly 100 as attached along a middle point of a metal component 110, an important benefit of the present invention is that, because of the strength of the magnetic attachment of the base of the support poles, a construction barricade can often be formed using only a single support pole assembly at each corner of the intended barricade area for the shorter barricade lengths common in construction site requirements, rather than having to use multiple candlestick cones along the entire perimeter of a protected area.

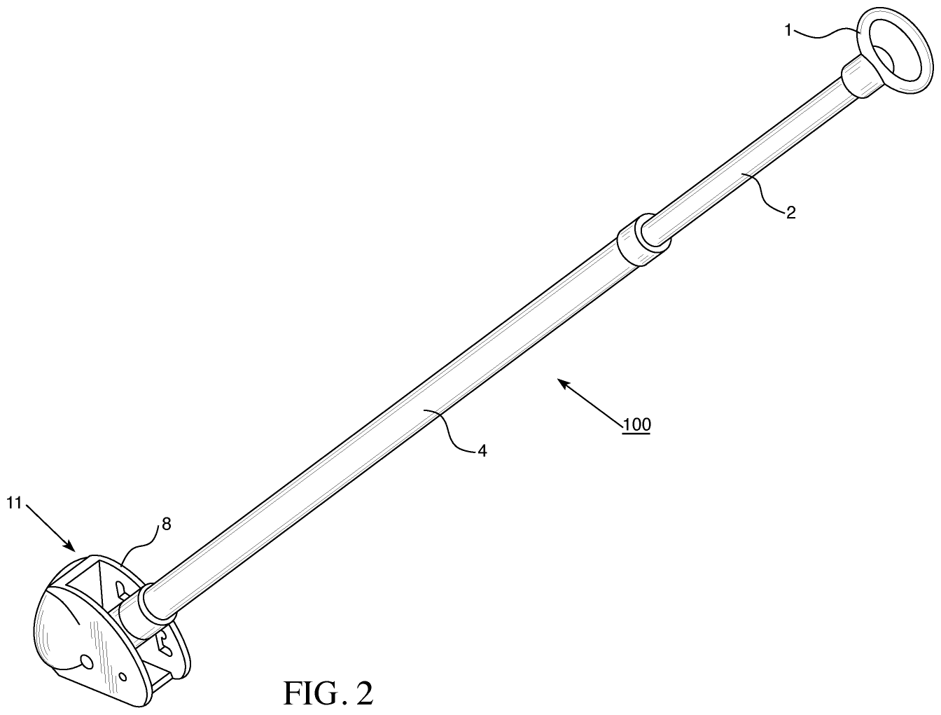

FIG. 2 shows the support pole assembly 100 in an isolated view of an exemplary embodiment in which the support pole assembly 100 comprises an outer pole 4 and an inner pole 2 slidably attached to the outer pole 4 in a telescoping manner. The eyelet 1 is attached to the distal tip of the inner pole 2. Although not visible in the view in FIG. 2, the base 8 has a plurality of magnet elements 11 which permits the base 8 to be magnetically attached to a ferromagnetic surface. In the exemplary embodiment shown in FIG. 2, three magnets are used, which together provide 300 pounds attachment force. Except for the magnet elements and attachment pins and screws, the components of this embodiment are made of a rigid plastic material such as, for example, a resin or fiberglass material, permitting the barricade tape support assembly 100 to be light in weight and easy to handle. Although the exemplary embodiment in FIG. 2 shows the support pole as being two slidably-connected poles 2, 4, other exemplary embodiments use only one pole section, which would typically be approximately four to five feet in length, and which could be either a hollow pole or a solid rod rather than a hollow pole. Additionally, it should be clear that more than two rod sections could be used in a slidably-connected configuration, or that the rod sections 2,4, could be interconnected in a manner other than a slidable connection. For example, the plurality of rod sections could be configured to slip together. However, a benefit of the slidably-connected mechanism is that the length of the rod can be easily adjusted.

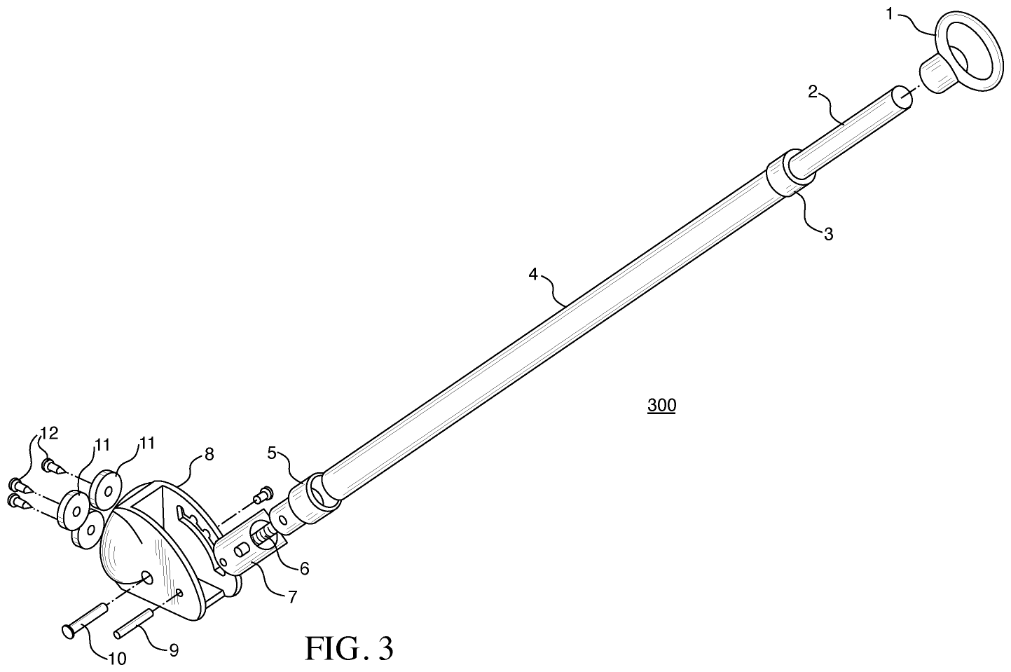

FIG. 3 illustrates an exploded view 300 of the exemplary prototype version shown in FIG. 2. The tip 1 is fitted onto the distal end of inner pole 2, and inner pole 2 is a hollow tube that telescopically slides into outer pole 4 through pole retainer piece 3. This design of using two pole sections slidably interconnected permits the pole section length to be changed as desired or required. The eyelet tip 1 is fitted to the distal end of the pole section 2 and is configured in this exemplary embodiment as being a loop (shown in perspective side view in this figure) through which barricade material can be threaded, although other shapes such as an oval, square, rectangular, etc., could be used for forming the eyelet 1.

In this exemplary embodiment, base 8 is also described as being a spring-loaded base because compression spring 6 provides compressive force that permits the angle of the pole sections 2,4 to be set at any of five different positions, 90σ, 67.5σ, 45σ, 22.5σ, and 0°, relative to the base 8, thereby allowing the assembly 100 to provide an effective barricade under many different mounting scenarios and orientations.

Base 8 is configured to accommodate a plurality of magnets 11 that are attached to the base 8 using fasteners 12 such as screws. It should be clear that other attachment means, such as an adhesive could be used to attach the magnets 11 to the base 8. Bushing 7 is pivotably attached to base 8 using a low-profile binding barrel pin 10 as the pivot, and permits the outer pole 4 to be connected to base assembly 8 via shaft 5.

Compression spring 6 provides a compressive force involved in capability to set the angle of the outer pole 4 to any of five preset angles. Lock pin 9 permits the outer pole 4 to be locked at any of five different angle positions. A push-button spring snap clip and pin (not shown) fits inside the inner pole 2 and is configured as a latching mechanism for selecting one of a plurality of preset lengths for the inner pole 2 relative to the outer pole 4.

Eyelet 1 is configured to attach to the distal tip of inner pole 2. In some exemplary embodiments, the rod tip/eyelet 1 is firmly attached to the inner pole 2 using a set screw, and in other exemplary embodiments, no set screw is used, for manufacturing cost saving since the rod tip can be configured for a sufficiently tight fit to the rod end without using a set screw.

Although the eyelet 1 is shown exemplarily in FIG. 2 with a solid circular configuration such that the barricade tape would be threaded therethrough, it is noted that alternate configurations are possible, since this eyelet 1 could have other shapes and could have a slit, either a traverse slit or a longitudinal slit, such as to permit the tape to be slid into the loop rather than threaded through. Additionally, the eyelet loop 1 could be configured to include a mechanism so that it can be opened and closed, using any of various mechanisms.

In a preferred exemplary embodiment, the base 8 is printed using a 3D printer, but it should be clear that the base 8 could be manufactured by other techniques such as, for example, an extruded molding technique. In a preferred embodiment, the base element 8, pole sections 2, 4, shaft 5, bushing 7, pole retainer 3, and eyelet 1 all have a primary surface color of orange.

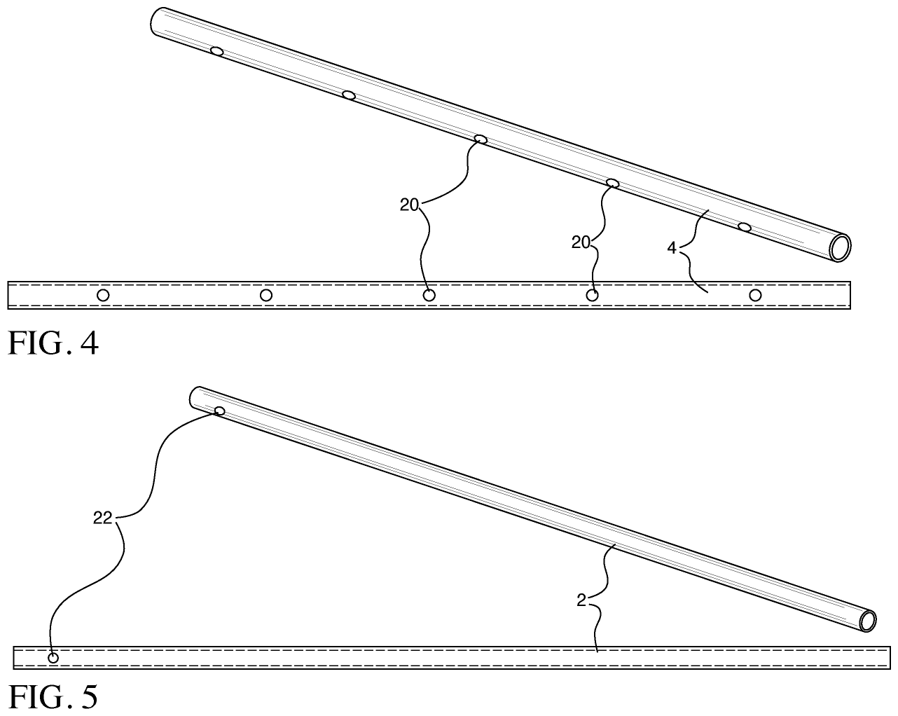

In a preferred embodiment, the rod comprises two sections 2, 4 which are slidably extendable from approximately 30 inches to 60 inches. Such length adjustment is possible because, as shown in FIG. 4, the outer pole 4 has a plurality of holes 20 spaced along its length so that, as shown in FIG. 5, the inner pole 2 has incorporated inside a hole 22 a push-button spring pin (not shown in FIG. 5) which permits the inner pole 2 to be latched in any one of the holes 20 along the length of the outer pole 4. In an exemplary embodiment, the pole sections 2, 4 are made of plastic/fiberglass resin and can be PVC (polyvinyl chloride) or similar material. The outer diameter of the outer pole rod 4 is approximately 1 inch to 1.5 inches in this exemplary embodiment, and the outer diameter of the inner pole 2 is approximately ¾ inch.

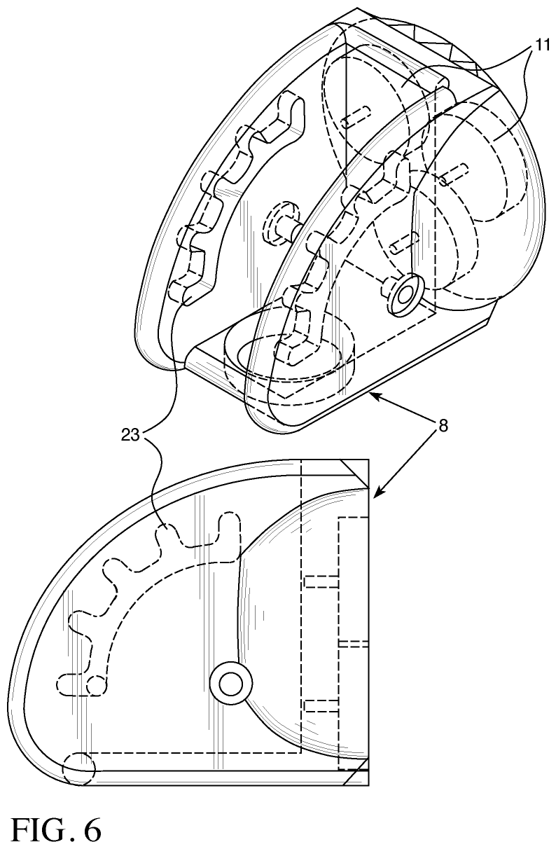

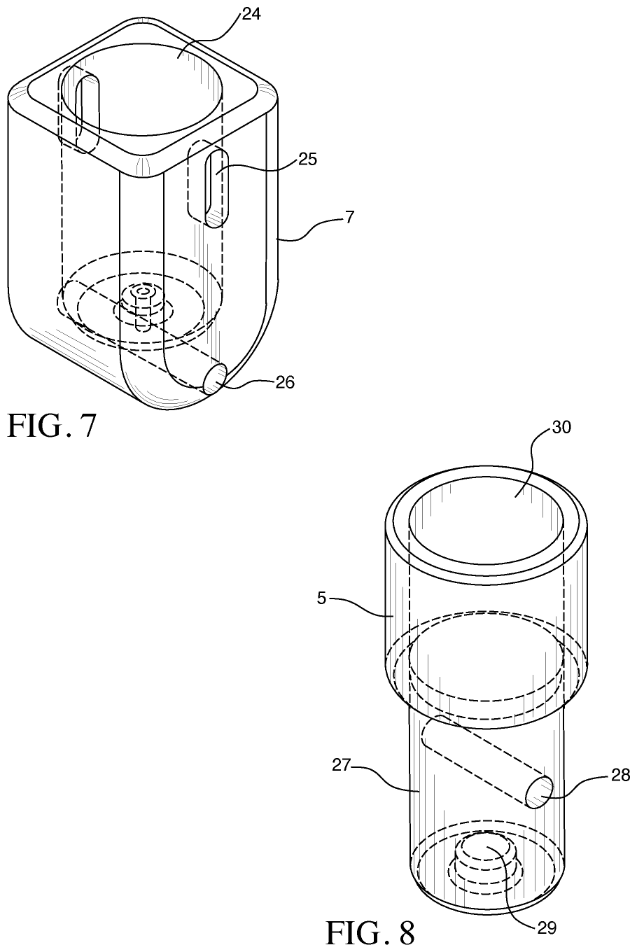

The mechanism that permits the poles 2,4 to be set as any of five predetermined angles is explained in reference to FIGS. 6, 7, & 8.

Thus, as exemplarily seen in FIG. 6, spring-loaded base 8 incorporates five detents 23 that provide latch positions to engage lock pin 9 (see FIG. 3) permitting different angles of the poles to be set at any of 0θ, 22.5σ, 45σ, 67.5σ, and 90°. It should be clear that the number of angle detents and the precise amount of different angle adjustments that are available are exemplary only and non-limiting to the intent and scope of the invention. FIG. 6 also shows the cavities in which the three magnet elements 11 are attached to the spring-loaded base 8.

FIG. 7 shows the bushing 7 having hole 26 by which the shaft 5 and poles 2, 4 are pivotably attached to base 8, using binding barrel pin 10 (see FIG. 3). Hole 24 is configured for holding the lower portion of the shaft 5 which in turn holds the proximal end of the outer pole 4, and slot 25 permits lock pin 9 to move up/down to permit angle adjustments (see FIG. 3). This up/down motion permits a user to change the angle of the poles 2, 4 by simply pushing downward against the compression spring 6 (not shown in FIG. 7), moving the poles 2, 4 to the desired angle, and releasing the pole to permit the compression spring 6 to push the lock pin 9 into the selected detent position 23.

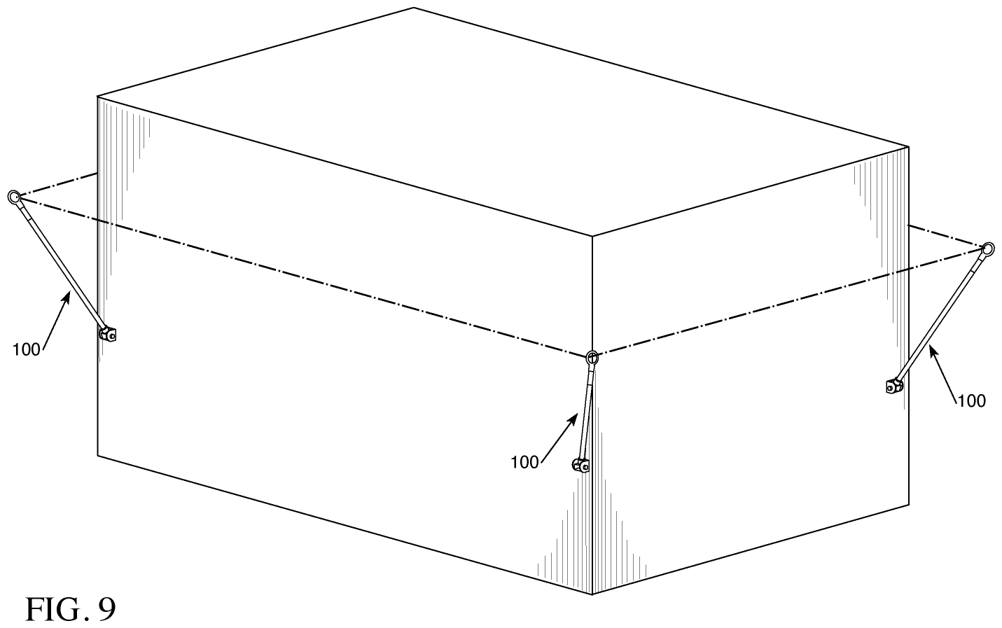

FIG. 8 shows details of the shaft 5 having cavity 30 to hold the proximal tip of outer pole 4, and the lower tip 27 of shaft 5 fits into the cavity 24 of bushing 7 shown in FIG. 7. Compression spring 6 (see FIG. 3) is seated on ridge 29 inside the lower tip 27 of shaft 5 to provide a force tending to push against lock pin 9 (see FIG. 3) inserted in hole 28 of shaft 5 to thereby push and latch the shaft 5 and lock pin 9 into one of the five angle detents 23 in base 8 to latch the poles 2,4 at the selected pole angle. In a prototype embodiment, the poles can be set at any of 0°, 22.5σ, 45σ, 67.5σ, and π°, but it should be clear that these are non-limiting in both quantity of possible setting positions or specific angles that can be selected.

It should also be clear that, as shown in FIG. 1, because the pole assembly 100 is attached using magnets 11, the entire assembly 100 can be rotated to any desired rotary angle between 0°-360° relative to the metal support structure 110 before attaching the base 8 to the metal support structure 110. Such rotary capability provides a way to orient the rod at additional angles relative to the underlying support structure.

Accordingly, FIG. 9 illustrates how, by adjusting the angle of the pole sections and selecting a rotary angle to mount the pole assembly to the underlying metal support, one assembly 100 at each corner of an area to be barricaded off could be used to form the barricaded area, in contrast to using additional supports midway along the perimeter as typically required when conventional rubber candlestick cones are used. This capability of reduced supports, one at each corner, is possible because the support pole of the present invention is strongly attached magnetically, thereby permitting to typically use support pole assemblies only at the corners of the desired barricaded area. Of, course, as exemplarily shown in FIG. 1, additional support pole assemblies could be used at middle points of the perimeter if desired or if the barricaded area is long and requires more than corner supports.

Although the exemplary embodiment described herein uses a spring-loaded base 8 to permit the angle of the pole 4 to be selectively adjusted, the present invention is not limited to this embodiment.

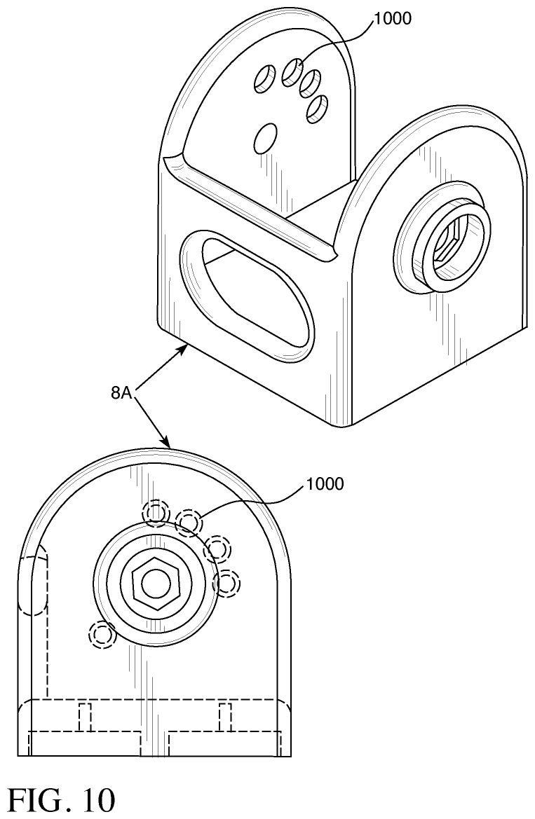

For example, FIG. 10 shows a base 8A in which the angle is selected and then set using pin(s) inserted into holes 1000 preformed in the base 8A. In yet other exemplary configurations, the angle of the pole is fixed at a specific angle of, for example, 90° or 45° relative to the underlying attachment surface. One of ordinary skill would readily understand that other mechanisms or fixed angles would be within the scope of the invention.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A construction barricade support assembly, comprising:
a pole section having a tip comprising an eyelet, wherein the eyelet is configured for threading barricade tape material therethrough; and
a base configured to support the pole section, the base including at least one magnet element to magnetically attach the construction barricade support assembly to a ferromagnetic material to be used as a support for the construction barricade support assembly.

2. The construction barricade support assembly of claim 1, wherein the base comprises a spring-loaded base structure comprising a plurality of detents and a compression spring, wherein each detent provides a different angle of the pole section relative to the base, and a selected detent position is locked in place by the compression spring.

3. The construction barricade support assembly of claim 1, wherein the pole section has a fixed length.

4. The construction barricade support assembly of claim 1, wherein the pole section has an adjustable length, and wherein the pole section comprises:
a first pole section fixedly attached at one end to the base around a pivot pin in the base; and
a second pole section slidably attached to the first pole section.

5. The construction barricade support assembly of claim 4, wherein the first pole section comprises a plurality of holes along its length, and wherein the second pole section comprises a spring-loaded push pin disposed inside the second pole section, and wherein the spring-loaded push pin is configured to lock the second pole section to one of the holes along the length of the first pole section.

6. The construction barricade support assembly of claim 1, wherein the base includes a plurality of magnet elements fixedly attached to a bottom surface of the base.

7. The construction barricade support assembly of claim 1, wherein the pole section comprises a polyvinyl chloride (PVC) material.

8. The construction barricade support assembly of claim 1, wherein a color of an exterior surface of both the pole section and the base is an orange color.

9. A construction barricade at a construction site, the construction barricade comprising:
a plurality of the construction barricade support assemblies of claim 1, at least one of the construction barricade support assemblies being magnetically attached to a ferromagnetic material at the construction site that supports the construction barricade support assembly; and
a length of barricade tape threaded through the eyelets of the plurality of construction barricade support assemblies.

10. The construction barricade of claim 9, wherein at least one of the construction barricade support assemblies is magnetically attached to a surface of a ferromagnetic material at the construction site that is oriented in a plane that is not horizontal.

11. The construction barricade of claim 10, wherein the surface of the ferromagnetic material is oriented in a vertical plane.

12. The construction barricade of claim 11, wherein the ferromagnetic material to which the construction barricade support assembly is magnetically attached and which is in the vertical plane comprises one of: a steel column or beam forming a component of a structure under construction at the construction site, a side of a steel storage or refuse container at the construction site, and a steel component of a piece of construction equipment at the construction site.

13. A method of making a barricade at a construction site, the method comprising:
attaching each of at least two of the construction barricade support assemblies of claim 1 to ferromagnetic material surfaces at the construction site; and
threading a length of a barricade tape through the eyelets at the pole section tips of each of the at least two construction barricade support assemblies.

14. The method of making a barricade of claim 13, wherein the ferromagnetic material to which the construction barricade support assemblies are magnetically attached comprises one of: a steel column or beam forming a component of a structure under construction at the construction site, a top of a steel cover plate covering an opening at the construction site, a side of a steel storage or refuse container at the construction site, and a steel component of a piece of construction equipment at the construction site.

15. The method of making a barricade of claim 13, further comprising setting an angle of a support pole in each of the at least two construction barricade support assemblies.

16. The method of claim 15, further comprising: pressing the support pole of at least one of the construction barricade support assemblies to cause that construction barricade support assembly to shift orientation relative to an edge of the construction barricade support assembly; and lifting the shifted construction barricade support assembly to separate it from its underlying ferromagnetic material, in order to one of move the shifted construction barricade support assembly to a new location and disassemble the barricade by detaching that construction barricade support assembly from its underlying ferromagnetic support.

17. A construction site barricade, comprising:
a plurality of construction barricade support assemblies, each construction barricade support assembly comprising a support pole with an eyelet at a distal end thereof; and
a continuous length of barricade tape threaded through the eyelets of the construction barricade support assemblies to form a barricaded area,
wherein each of the construction barricade support assemblies is magnetically attached to a surface of a ferromagnetic material in the construction site.

18. The construction barricade of claim 17, wherein each of the construction barricade support assemblies comprise an angle setting mechanism that permits the support pole of that construction barricade support assembly to be set to a desired angle relative to the surface of the ferromagnetic material supporting that construction barricade support assembly.

19. The construction barricade of claim 17, wherein each of the construction barricade support assemblies can be selectively detached from the surface of its underlying ferromagnetic material by pressing the support pole of that construction barricade support assembly to cause that construction barricade support assembly to shift orientation relative to an edge of the construction barricade support assembly; and lifting the shifted construction barricade support assembly to separate it from its underlying ferromagnetic material, in order to one of move the shifted construction barricade support assembly to a new location and disassemble the barricade by detaching that construction barricade support assembly from its underlying ferromagnetic support.
